(19) United States
(12) Patent Application Publication
(10) Pub. No.: US 2011/0166481 A1
(43) Pub. Date: Jul. 7, 2011

(54) Clamp and back scratcher assembly and method

(75) Inventors: John Daniel Rhoad, Chapin, SC (US); Curtis Ray Bair, Orangeburg, SC (US); Roger Blaine Trivette, Boiling Springs, SC (US)

(73) Assignee: CuDa Enterprises, LLC, Chapin, SC (US)

(21) Appl. No.: 12/655,611

(22) Filed: Jan. 4, 2010

(51) Int. Cl. A61H 1/00; F16M 13/00

(52) U.S. Cl. 601/1; 248/231.51

(57) ABSTRACT

A clamp mechanism for attachment to door frames or other support structures is provided. The clamp mechanism includes a face plate and a pair of side plates. The side plates have a series of holes for receiving a cam assembly, which is used to attach the clamp mechanism to a door frame through frictional engagement to the backside of the molding on the door frame. The face plate is adapted to receive removable inserts, which may include back scratching or massaging devices, as well as inserts for other types of uses. The clamping mechanism may be manufactured by injection molding, and the components may be assembled and disassembled without the use of tools.

### BACKGROUND OF THE INVENTION

The present invention relates generally to clamp mechanisms for temporary attachment to door frames and the like. More specifically, the present invention relates to a clamp that may include a variety of removable attachments that are useful as back scratching devices, as well as other types of removable attachments or inserts.

Heretofore, many different types of mountable back scratching devices have been developed and commercialized. One example is disclosed in U.S. Pat. No. 6,110,132, and includes a base member having two plates disposed at a 90° angle with respect to one another, and a bristle carrier attached to the base. This device may be mounted to the corner of a wall or a door frame with nails, screws or bolts. U.S. Pat. No. 7,011,639 is directed to a back massaging device that may be mounted to a wall. Yet another example of a door frame mounted back massaging device is disclosed in U.S. Pat. No. 3,279,463. U.S. Pat. No. 4,733,842 is directed to a multi-purpose clamp that may be attached to a support structure using a series of adjustable hinged panels, and which may have attachments that are used as back massaging devices.

However, it would be desirable to provide a clamping mechanism and back scratching or massaging device that could be manufactured using injection molding, and which provides a low profile configuration that may be temporarily but securely secured to a support structure such as a door frame. Additionally, it would be desirable to provide a secure clamping mechanism that may be removably attached to a door frame, wherein the clamping mechanism is adapted to receive removable inserts that may be used for many different purposes.

### BRIEF SUMMARY OF THE INVENTION

In accordance with one aspect of the invention, a clamping mechanism is provided for temporary attachment to a door frame, wherein the clamping mechanism includes removable attachments that may be used as a back scratching or massaging device. The clamping mechanism includes three panels, one face panel and two side panels that may be removably attached to each other. Each side panel includes a series of holes on an upper portion thereof, and a second series of holes on a lower portion thereof. Attachment means, in a preferred embodiment, include a set of cam members, each having a shaft and a handle member. The shaft is placed through one of the holes in the side panel, and a cam is attached to the shaft on an inner portion of the side panel. The handle member is attached to the shaft on an outer side of the side panel. In a preferred embodiment, four cam assemblies (cam, shaft and handle) are used to secure the clamping mechanism to a door frame, wherein each side panel includes two cam assemblies, one set in a selected hole from the upper series of holes, and one set in a selected hole from the lower series of holes.

When the clamping mechanism is positioned on a door frame in the desired location, a user may simply rotate the handles, thus rotating the cam members so that they come into contact with the backside of the molding surrounding the door frame. As the handles are rotated, the cams frictionally engage the molding and secure the clamp mechanism thereto. The face panel includes means for attaching removable back scratching or massaging inserts. An insert may include a series of rotating balls, flexible protrusions, or any other texturized surface that may be desirable for use as a back scratcher or massager. Additionally, other types of inserts may be attached to the face plate for any desired purpose, such as inserts having hooks for hanging clothing or hats, or inserts having slots for receiving mail or other papers, for instance.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of the clamp assembly;

FIG. 2A is a front view of one embodiment of the face panel;

FIG. 2B is a perspective view of one embodiment of the face panel;

FIG. 2C is a rear view of one embodiment of the face panel;

FIG. 3A is a front view of one embodiment of the side panel;

FIG. 3B is a perspective view of one embodiment of the side panel;

FIG. 4A is a side view of one embodiment of the handle and shaft member;

FIG. 4B is a perspective view of one embodiment of the handle and shaft member;

FIG. 5A is a front view of one embodiment of the cam member;

FIG. 5B is a perspective view of one embodiment of the cam member;

FIG. 6A is a perspective view of one embodiment of the clamping mechanism in use, attached to a door frame, and showing a back scratching insert removably attached thereto; and

FIG. 6B is a perspective view of one embodiment of the clamping mechanism in use, attached to a door frame, and showing another embodiment of a back scratching insert removably attached thereto.

### DETAILED DESCRIPTION OF THE INVENTION

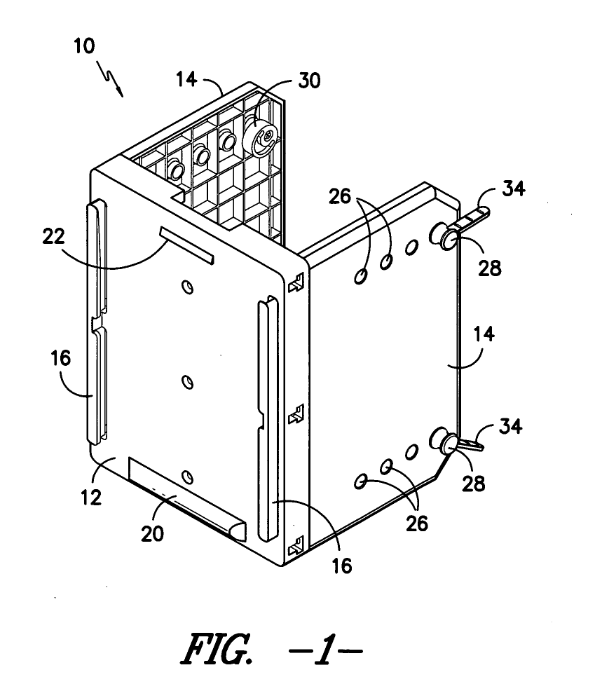

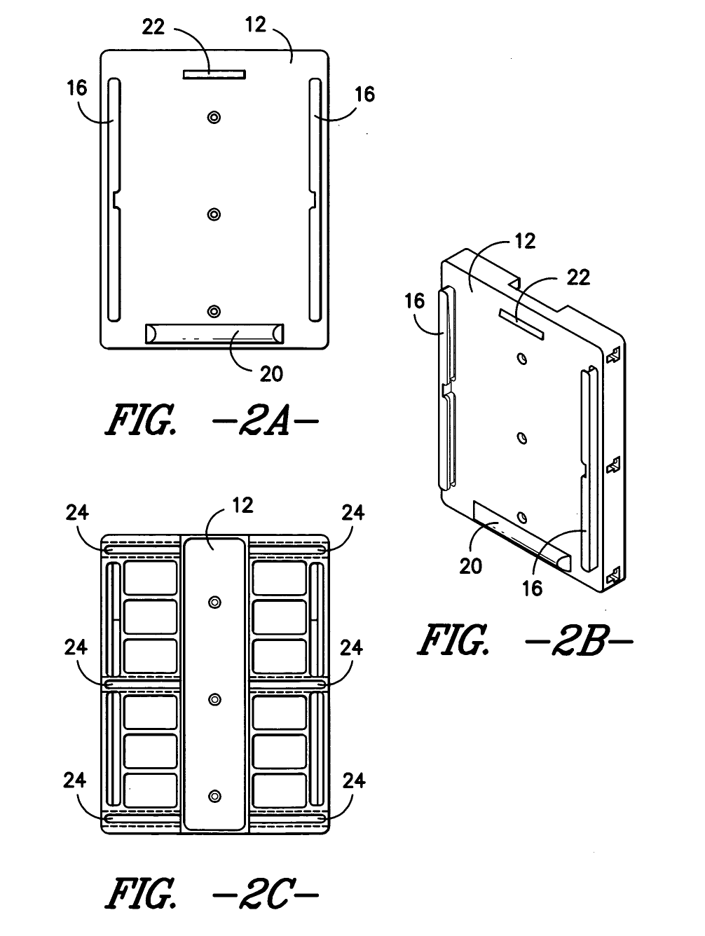

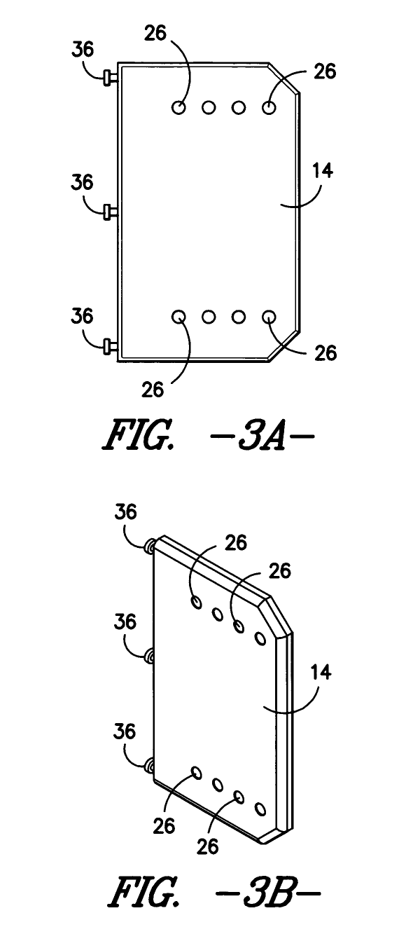

A first embodiment of a novel clamp mechanism 10 assembly is shown in FIG. 1. In a preferred embodiment, the clamp mechanism includes three panels: a face panel 12 and two side panels 14. The face panel 12 in this embodiment, as shown in FIGS. 2A, 2B and 2C, includes a pair of tracks 16 running vertically along each front side thereof for receiving a removable insert 18. A lower lip 20 is disposed horizontally along the bottom front side of the face panel 12, and the lower lip serves as a stop and support for a removable insert 18. In a preferred embodiment, an upper lip 22 is disposed on the front of the face panel 12, and is used to hold the removable insert 18 in place. Optionally, instead of an upper lip 22, a flexible latch member may be positioned on a top portion of the front of the face panel in order to retain the removable insert, and is preferably disposed in a central location along the top.

On the rear portion of the face panel 12 in this embodiment, a series of retention slots 24 are disposed in a horizontal orientation on both sides thereof. Three retention slots 24 are positioned on each side of the rear portion of the face panel 12, one on an upper portion, one which is centrally located, and one positioned along a bottom portion. The retention slots 24 are open at the end of the slot that is closest to the center of the face plate 12, and the opposed end adjacent the sides of the face panel 12 are closed. These retention slots 24 are used to receive the attachment means positioned on the side panels 14, for attachment of the side panels 14 to the face panel 12. It is contemplated that the number of retention slots 24 and side panel attachment means may be decreased or increased as desired, depending on the size and shape of the assembly.

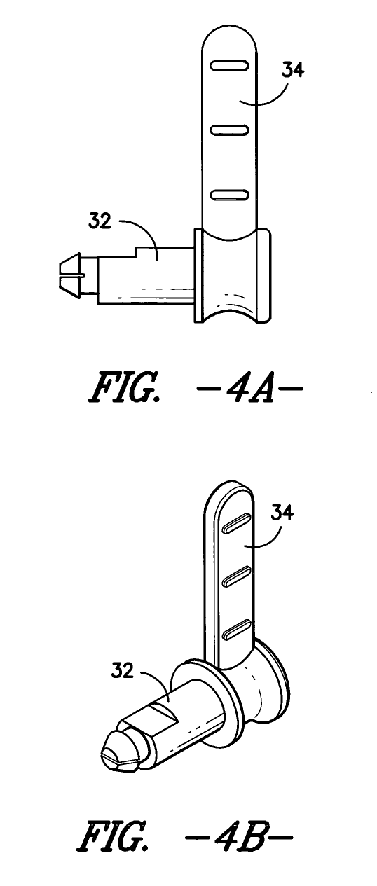

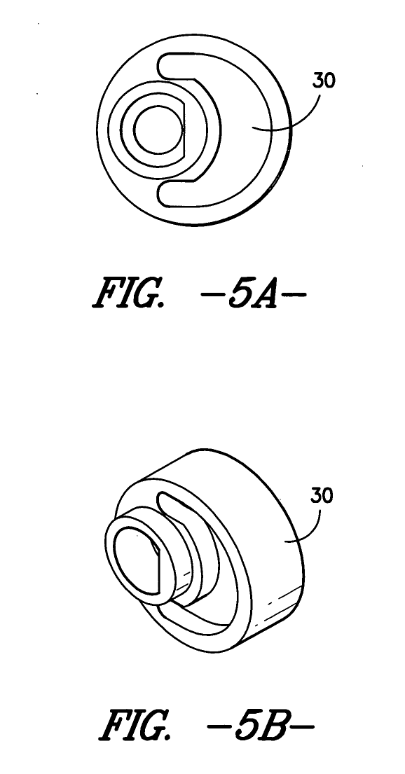

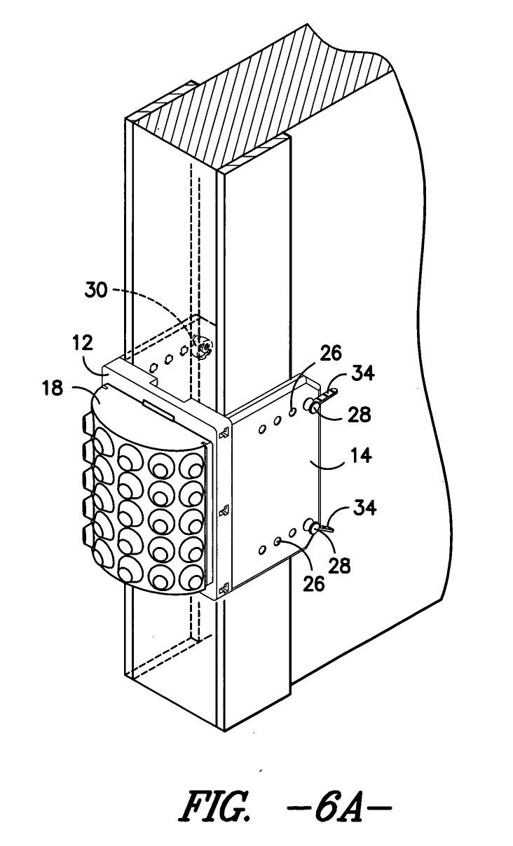

The side panels 14, as shown in FIGS. 3A and 3B, preferably include a series of holes 26 in a horizontal line along an upper portion thereof, and a corresponding series of holes 26 in a horizontal line along a lower portion thereof. These holes 26 are used to receive a cam assembly 28, which consists of a cam member 30, a shaft member 32 and a handle member 34. In a preferred embodiment, the shaft member 32 and the handle member 34 are integrally formed, and may snap into a hole disposed within the cam member 30. This snap fit relationship allows the cam assembly to be removably placed into any of the holes 26, and the hole 26 selected depends on the size and shape of the particular door frame or support structure that the clamping mechanism 10 will be attached to. In use, four cam assemblies 28 are used, and are disposed in corresponding holes 26 (one cam assembly 28 in the upper series and one cam assembly 28 in the lower set of holes on each side panel 14). The handle members 34 are disposed on an outside of the side panels 14, while the shaft member 32 extends through the hole 26 in the side panel 14, and the cam member 30 is positioned on an opposed end of the shaft member 32 on an inside (or back) portion of the side panels 14.

Assembly means are disposed on one side of each side panel. In a preferred embodiment, the assembly means include a series of protruding pins with a circular head fixed on an end of each pin. The pins and heads, hereafter referred to as spigots 36, are positioned to correspond with the retention slots 24 on the back of the face panel 12. In order to attach a side panel 14 to the face panel 12, the spigots 36 are inserted into the open end of the retention slots 24, and the side panel 14 slides outwardly toward one side of the face panel 12. It is contemplated that rubber O-rings or washers (not shown) may be disposed about the spigots 36 on an underside of each round head, in order to provide additional frictional engagement between the side panels 14 and the face panel 12 so that the side panels 14 do not slide within the retention slot 24 when the clamping mechanism 10 is secured to a door frame.

After the clamping mechanism 10 has been assembled, it may be positioned on a door frame and secured thereto by rotating the handle members 34, which in turn rotate the cams 30. When the clamping mechanism 10 is positioned on a door frame in the desired location, a user may simply rotate the handles 34, thus rotating the cam members 30 so that they come into contact with the backside of the molding surrounding the door frame. As the handles 34 are rotated, the cams 30 frictionally engage the molding and secure the clamp mechanism 10 thereto.

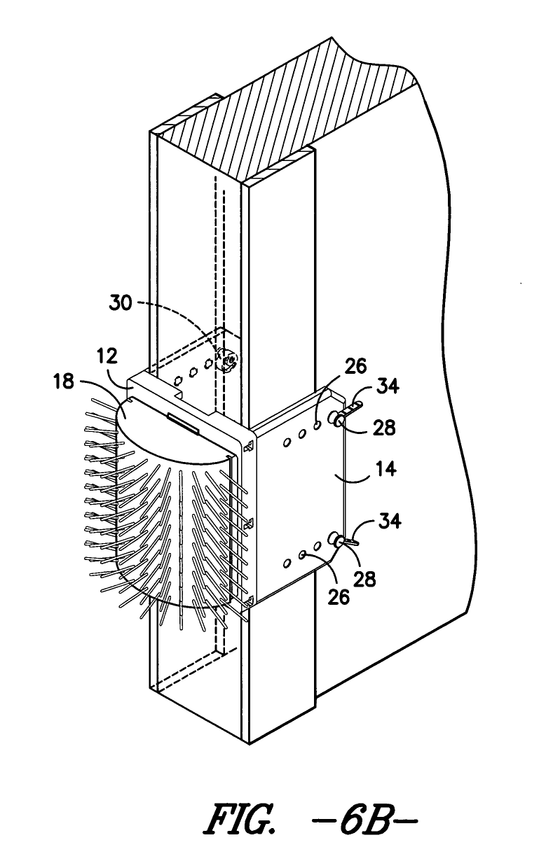

The removable inserts 18 may take many forms. In one embodiment, the removable insert 18 includes a texturized surface that is useful for back scratching or massaging. The texturized surface may include a series of protrusions or fingers (as shown in FIG. 6B), spherical or half spherical shapes (as shown in FIG. 6A), or any other desired surface. Other embodiments may include ball and socket assemblies, where the balls may rotate in any angular direction, or may include rollers that roll about an axis. Additionally, the removable insert 18 may include the shape of an object, such as a bear, a bear claw, a portion of a tree, or any other desired shape. When the back scratching or massaging inserts are used, a user simply attaches the inserts 18 to the clamp assembly 10, which is positioned on a door frame or the like, and the user may simply back up to the assembly 10 so that his or her back comes into contact with the insert 18, and then moves so that the insert 18 scratches or massages the user's back.

The inserts 18 are adapted to fit within the tracks 16 on the front of the face panel 12. In order to attach an insert 18 to the face panel, a user slides the insert 18 into the tracks at the upper portion of the face panel 12, and then slides the insert 18 down along the tracks 16 until it comes to rest on the lower lip 20 along the bottom of the face panel. The upper lip 22 (or optionally, the flexible latch) at the top of the face panel 12 is positioned to secure the insert 18 therein. In order to remove the insert 18 from the face panel 12, a user simply pulls the insert 18 away from the face panel 12 (or disengages the flexible latch at the top of the face panel), and then slides the insert 18 upwardly until it is free of the tracks 16 along the side of the face panel 12.

It is also contemplated that the removable inserts 18 may take other forms as well, for other purposes. For instance, an insert 18 may include: slots to receive mail or other papers, a dry erase board, a height measurement tool, a frame for pictures or a mirror, a hook or hanger for hats and coats, a planter for plants or flowers, or a cat scratching post or other pet toy, or any other desired attachment.

The clamp assembly 10 and the removable inserts 18 may be manufactured from plastic by an injection molding process, although other manufacturing processes may be utilized. Because the side panels 14, the cam assemblies 28, the face panel 12 and the inserts 18 may all be disassembled, all of the components may be stored in a compact manner when the assembly is not in use. Additionally, it is advantageous to provide such a device that may be assembled, used, and disassembled without the necessity of using any tools. The clamp assembly 10 is designed so that it may be secured to door frames of varying shapes and sizes.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A clamp assembly comprising:
a face panel;
a pair of side panels attached to said face panel;
attachment means disposed on each side panel for attaching said clamp assembly to a support structure; and
a removable insert attached to a front side of said face panel.

2. The clamp assembly set forth in claim 1, wherein said face panel is removably attached to said pair of side panels.

3. The clamp assembly set forth in claim 2, wherein said side panels each include a series of spigots disposed on one side thereof, and wherein said face panel includes a series of retention slots on a rear side thereof corresponding to said spigots on said side panels so that said side panels may be attached to said face panel using said spigots and said retention slots.

4. The clamp assembly set forth in claim 1, wherein said attachment means includes at least one cam assembly.

5. The clamp assembly set forth in claim 4, wherein said cam assembly includes a cam member and an integrally formed shaft member and handle member, wherein said cam member and said integrally formed shaft member and handle member may be removably attached to one another.

6. The clamp assembly set forth in claim 1, wherein said attachment means includes multiple cam assemblies.

7. The clamp assembly set forth in claim 1, wherein said removable insert includes a back scratching or massaging device.

8. The clamp assembly set forth in claim 1, wherein said attachment means are adjustable, so that said clamp assembly may fit onto support structures of varying shapes and sizes.

9. The clamp assembly set forth in claim 1, wherein said face panel includes a vertical track disposed on a front side thereof, wherein said tracks are positioned on either side of said face panel for receiving said removable insert.

10. The clamp assembly set forth in claim 9, further including a flexible latch member disposed on a top portion of said face panel for securing said removable insert thereto.

11. The clamp assembly set forth in claim 1, wherein said side panels each include a first set of holes disposed along a horizontal line along an upper portion thereof, and each include a second set of holes disposed along a horizontal line along a lower portion thereof, wherein said holes are adapted to receive said attachment means.

12. The clamp assembly set forth in claim 1, wherein said removable insert includes at least one ball and socket mechanism allowing said ball to rotate in any direction within said socket.

13. The clamp assembly set forth in claim 1, wherein said removable insert includes a plurality of flexible protrusions.

14. The clamp assembly set forth in claim 1, wherein said removable insert includes a feature selected from the group consisting of: at least one slot adapted to hold mail and papers, a dry erase board, a height measurement tool, a mirror, a picture, a pet toy, a hook for hats and coats, or a planter for plants.

15. A clamp assembly comprising:
a face panel;
a pair of side panels attached to said face panel; and
attachment means disposed on each side panel for attaching said clamp assembly to a support structure.

16. The clamp assembly set forth in claim 15, wherein said face panel is removably attached to said pair of side panels.

17. The clamp assembly set forth in claim 16, wherein said side panels each include a series of spigots disposed on one side thereof, and wherein said face panel includes a series of retention slots on a rear side thereof corresponding to said spigots on said side panels so that said side panels may be attached to said face panel using said spigots and said retention slots.

18. The clamp assembly set forth in claim 15, wherein said attachment means includes at least one cam assembly.

19. The clamp assembly set forth in claim 18, wherein said cam assembly includes a cam member and an integrally formed shaft member and handle member, wherein said cam member and said integrally formed shaft member and handle member may be removably attached to one another.

20. The clamp assembly set forth in claim 15, wherein said side panels each include a first set of holes disposed along a horizontal line along an upper portion thereof, and each include a second set of holes disposed along a horizontal line along a lower portion thereof, wherein said holes are adapted to receive said attachment means.
